(19) United States
(12) Patent Application Publication
(10) Pub. No.: US 2003/0153091 A1
(43) Pub. Date: Aug. 14, 2003

(54) Pre-moistened applicators for chemical reactant delivery

(76) Inventors: Dean M. Willard, New York, NY (US); Mark W. Feist, Colchester, CT (US); Hans E. Haas, Stow, OH (US); Marcia Snyder, Stow, OH (US); Jonathan D. Zook, Santa Clarita, CA (US)

Correspondence Address: Gifford, Krass, Groh, Sprinkle,, Anderson & Ctikowski, P.C., Suite 400, 280 N. Old Woodward Avenue, Birmingham, MI, 48009-5394, US

(21) Appl. No.: 10/073,717

(22) Filed: Feb. 11, 2002

(51) Int. Cl. G01N 31/22

(52) U.S. Cl. 436/174; 436/77; 436/80; 436/82; 422/56; 422/58; 422/61; 422/99

(57) ABSTRACT

An article for delivery of a chemical reactant includes a liquid or solvated chemical reactant pre-moistened into an applicator. A chemical reactant impervious package has a pouch adapted to enclose the applicator for storage. The chemical reactant delivery article is based on capillary action to wick the continuing supply of chemical reactant to the substrate contacting portion of the applicator and as such is operative independent of chemical reactant gravitational flow.

### FIELD OF THE INVENTION

The present invention generally relates to chemical reactant application, and more particularly, to pre-moistened applicators for such a reactant.

### BACKGROUND OF THE INVENTION

Many polymerization reactions progress under anaerobic conditions. The desire to induce polymerization under field conditions or absent equipment necessary to control the atmosphere during polymerization requires that polymerization components be pre-packaged to inhibit degradation associated with oxygen or humidity exposure.

It is common that single-use polymerization adhesives that cure best under anaerobic conditions are packaged to assure that the air-sensitive polymerization catalyst is maintained during storage. Such polymerization catalysts have traditionally been provided in swab ampules that include an interior, breakable, sealed glass capsule containing the catalyst in flowable liquid form. An outer protective sheath or vial is formed from plastic sheeting such as polyethylene, polyvinyl chloride, or other conventional polymeric materials. This outer protective sheath is sealed at one end and terminates at the other end in a spongeous, liquid permeable piece. In operation, a substrate is pre-cleaned and the glass capsule within the ampule is broken thereby releasing catalyst containing liquid to feed by gravity into the spongeous applicator piece while the fragmented glass capsule is ideally retained within the polymeric protective sheath. Conventional ampules of this type are typically many times more expensive to prepare than the cost of the polymerization catalyst contained therein. Additionally, a safety hazard exists in the event that the outer polymeric sheath is punctured during the shattering of a glass vial with a user's fingers. A further limitation of conventional ampules is the need to orient the ampule above the substrate to maintain liquid flow. In light of the expense, hazard, and application orientation associated with delivery of anaerobic polymerization catalysts in such ampules, there exists a need for a chemical reactant applicator that retains the function of the reactant during storage and overcomes the limitations of conventional ampules.

### SUMMARY OF THE INVENTION

An article for chemical reactant delivery includes a liquid chemical reactant under delivery conditions or a solvated chemical reactant that is pre-moistened into an applicator. A chemical reactant impervious package has a pouch adapted to enclose the applicator. The applicator wicks the chemical reactant to the substrate contact surface through capillary action and is in the form of a wipe, a prep pad, a swab stick or a sponge. A process for applying an adhesive to a substrate involves exposing a capillary action fed applicator pre-moistened with a solvated or liquid chemical reactant and contacting the applicator with a first substrate independent of user contact with the applicator. A film of the chemical reactant is then applied to the substrate and a second substrate is brought into contact with the first substrate with a curable material and the chemical reactant therebetween. A commercial package including an article for chemical reactant delivery includes a solvated or liquid under delivery conditions chemical reactant pre-moistened into an applicator that is stored within a chemical reactant impervious package having a pouch adapted to enclose the applicator, along with instructions for the use thereof as a pre-moistened applicator for the chemical reactant. The use of a selectively peelable or tearable package for applying a chemical reactant pre-moistened into an applicator is also disclosed.

### BRIEF DESCRIPTION OF THE DRAWINGS

FIGS. 1A-C are planar, cross-sectional, and perspective views, respectively, of an inventive embodiment; and

FIGS. 2A-C are planar, cross-sectional, and perspective views, respectively, of another inventive embodiment.

### DESCRIPTION OF THE PREFERRED EMBODIMENTS

The present invention overcomes the limitations of conventional ampules by packaging a chemical reactant as a pre-moistened wipe, prep pad, swab or stick that is stored within a package formed from metal foil having an inner coating or layer of catalyst and catalyst solvent compatible thermoplastic material. Alternatively, the pre-moistened applicator is within a package formed of a puncture- or tear-resistant thickness of a suitable catalyst and catalyst solvent compatible thermoplastic material. The present invention utilizes capillary action within an applicator to deliver a chemical reactant, in contrast to gravity fed applicators common to the art.

As used herein, a pre-moistened applicator is defined as a wipe, a prep pad, a swab, a swab stick and a sponge wetted with a liquid chemical reactant or a solvated chemical reactant.

As used herein, a chemical reactant is defined as a reaction catalyst, a primer, an activator, an adhesion promoter and a polymerization monomer.

In the attachment of non-siliceous materials to a glass substrate the present invention finds a particular utility. The attachment of a rearview mirror mount to a vehicle windshield is exemplary to the present invention. An inventive package is torn or peeled to expose an applicator pre-moistened with the anaerobic cure adhesive catalyst. The applicator contacts the glass substrate to leave a thin film of catalyst material in a desired bonding region of the substrate. Optionally, any solvent accompanying the catalyst onto the substrate is given sufficient time to volatilize. The curable adhesive is then applied of the catalyst and the metal (or other material) mount substrate is brought into contact with the glass substrate such that the catalyst indicated anaerobically curing adhesive is therebetween for a time sufficient to allow cure to occur.

An additional advantage of the present invention over the conventional swab ampule is the ability to apply a chemical reactant with greater uniformity in substrate geometries where a gravity fed ampule swab is not in fluid contact with the catalyst reservoir. The solvated or liquid chemical reactant is applied to a pre-moistened applicator according to the present invention by soaking the applicator in a solution, spraying the solution onto the applicator, or by an injection technique into the article during manufacture. The identity of the solvent is largely dictated by the solubility characteristics of the chemical reactant and compatibility of that solvent with the other chemical reactants. Solvents operative herein illustratively include: water, C₂-C₂₀ linear or branched alkanes; ethers; esters; alcohols; ketones; aldehydes; acids; C₆-C₁₀ aromatics and substituted aromatics; furans; and chlorinated, brominated, and fluorinated forms thereof; plasticizers; oils, such as DOP; and liquid resins such as triEGMA and PEGMA.

The chemical reactant illustratively includes the following classes of materials: main group and lanthanide series organometallics, coordination complexes of main group and lanthanide series metal salts and more specifically organo-tin compounds and organo-copper compounds, and copper acetyl acetonate or aldehyde amine condensates, which are catalysts known to the art to be active as anaerobic polymerization catalysts and/or primers. It is appreciated that a chemical reactant that is a liquid under application conditions is optionally not solvated or otherwise diluted within the present invention.

Contrary to prior art, pre-moistened applicators which contained personal care astringents, biocides or cleaning solutions, an inventive solvated chemical reactant is prone to degradation by skin contact or act as a skin irritant. As a result, care is taken upon opening the package to avoid skin contact with the pre-moistened applicator contained therein. Skin contact is avoided either through use of applicator solvent- and catalyst-impervious gloves or cots, forceps, tweezers or preferably, a package peelable to expose the pre-moistened applicator while shielding the same from user contact.

While the present invention is described with a catalyst component of a multi-component chemical reaction being in a pre-moistened applicator package, it is appreciated that the present invention is also operative to contain a variety of multiple function components involved in a chemical reaction. Exemplary multiple function pre-moistened applicators include in combination a substrate cleaner-primer, a substrate cleaner-catalyst, and a substrate cleaner-adhesion promoter. It is further appreciated that substrate cleaning may be completed by a chemical reactant solvent alone or in combination with a surfactant, an acid or a base.

Absorbent materials in packaging systems operative herein include those detailed in U.S. Pat. Nos. 3,542,634; 3,057,467; and 4,696,393, each of which is herein incorporated by reference. Preferably, the package according to the present invention retains the package in the contained pre-moistened applicator attached thereto as prior U.S. Pat. No. 4,696,393. In the context of the present invention, the applicator pre-moistened with a solvated chemical reactant is exposed by flaring the package flaps to expose the pre-moistened applicator therein. By holding onto the base of the package, the pre-moistened applicator contents are spread onto a substrate and after use, the package opening flaps are again brought into contact, thereby containing the spent applicator therein, all without skin contact with the applicator.

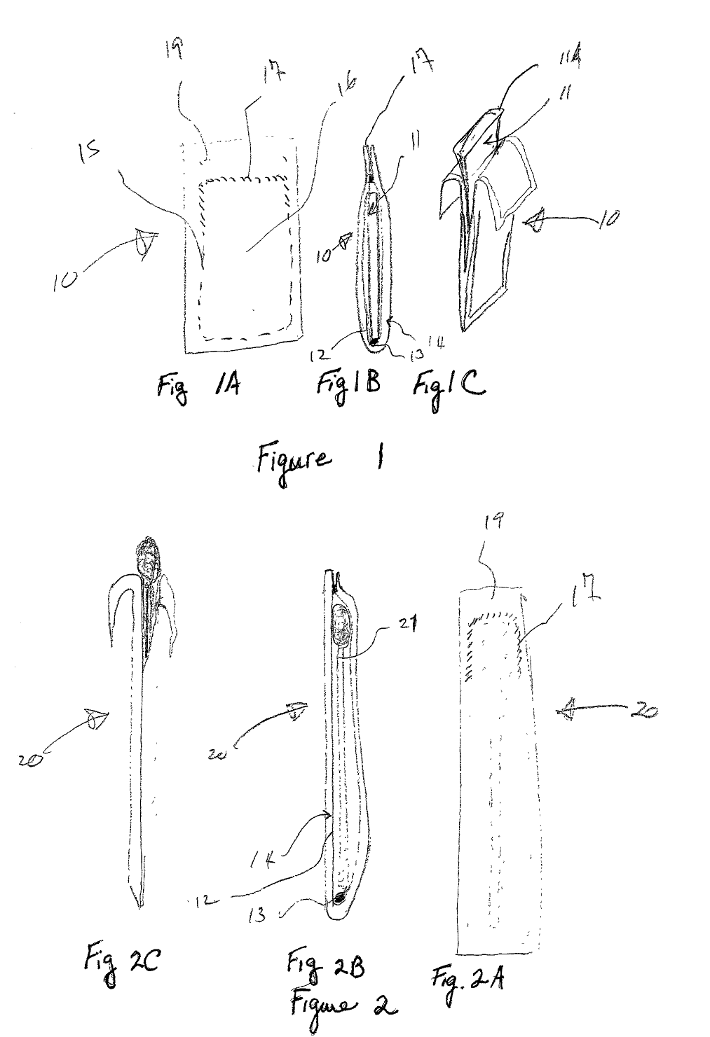

Referring now to the drawings, where like referenced numerals denote by components among several figures. In FIGS. 1A-1C, an inventive pre-moistened applicator article is shown generally at 10. The article 10 includes a pre-moistened applicator pad 11 optionally attached to the package inner surface 12. Optionally, the applicator tip 11A that is exposed upon pulling back on package flaps, is of a greater thickness than the remainder of the applicator pad in order to wick additional catalyst onto the portion the applicator contacting a substrate. The attachment 13 between the applicator 11 and the inner surface 12 of package 14 illustratively includes contact adhesive, solvent weld, thermal fusion, thermoset adhesive. An intendedly permanent seal 15 proximal to the edges of the package 14 extends around a portion of the package periphery to define a pouch 16 having an opening 17. The opening 17 is selectively sealed for storage with a breakable seal material 18. The breakable seal 18 is illustratively an adhesive seal, a heat seal, pressure seal or combination thereof that is compatible with the solvent and catalyst impregnated in the applicator 11, as well as the package materials. Preferably, a flap 19 extends beyond the breakable seal 17 to facilitate opening of the seal 17 to expose the pre-moistened applicator 11.

With reference to FIGS. 2A-2C, a pre-moistened applicator swab stick 21 is encased within an article shown generally at 20.

The following examples are intended to give operative embodiments and comparatives of the present invention. The compositions and properties detailed herein are only intended to be exemplary and not limiting as to the scope of the invention detailed in the appended claims.

### EXAMPLE 1

### Comparison between Conventional Ampule and Inventive Applicator Adhesive

### Test Methods and Materials

Commercial alcohol prep pads were obtained, the cotton pads removed from the package and dried. The pads were impregnated with various primers and the surfaces of steel lap shears that were pre-cleaned with isopropanol were wiped with the primer pads in a uniform motion. The lap shears were bonded with an anaerobic adhesive and allowed to dry for 24 hours at ambient temperature. The force to pull the laps apart was determined using an Instron Tensile Tester in accordance with ASTM D1002, which is incorporated herein by reference.

### Components/Raw Materials

Cotton prep-pads: 1¼×2⅛″, impregnated with ˜0.40 grams primer solution

Conventional primer ampules

Adhesive A: Control; Permatex part #81844—1 drop per lap shear set

Primer A: Control; Permatex part #81844 activator

Primer B: Copper naphthenate in isopropanol

Primer C: Copper octoate in isopropanol

Primer D: Copper octoate in heptane

TABLE 1
Primer Applied by Conventional Ampule
vs Inventive Applicator Primer Wiped On

| | Primer Application | Tensile Strength (psi) |
|---|---|---|
| Primer A | ampule | 2,552 +/− 141 |
| Primer A | ampule | 2,543 +/− 259 |
| Primer A | inventive applicator | 2,310 +/− 162 |
| Primer A | inventive applicator | 2,605 +/− 334 |
| Primer B | ampule | 2,679 +/− 398 |
| Primer B | inventive applicator | 3,035 +/− 155 |
| Primer B | inventive applicator “dry pad” | 2,672 +/− 341 |
| | (pad dried 2.5 minutes then applied) | |
| Primer B | inventive applicator | 2,727 +/− 184 |
| Primer B | “inventive applicator “aged wipe” | 2,327 +/− 361 |
| | (pad aged @ 50° C. 1 month) | |
| Primer B | inventive applicator | 2,604 +/− 226 |

Results reported are averages of 3-5 laps per set.

Primers used in conjunction with Adhesive A in all cases.

TABLE 2
Baseline Tensile Strengths for Conventional
Ampule Applied Primers on Clean Lap Shears

| Primer Type Comparison- | |
|---|---|
| Conventional Ampule Applied | |
| Primer Used with Adhesive A | Tensile Strength (psi) |
| Primer A - Trial 1 | 2,815 +/− 102 |
| Primer A - Trial 2 | 2,619 +/− 338 |
| Primer B - Trial 1 | 2,500 +/− 194 |
| Primer B - Trial 2 | 2,798 +/− 371 |
| Primer C | 2,430 +/− 271 |
| Primer D | 2,628 +/− 334 |

### EXAMPLE 2

### Inventive Applicator as Cleaner and Primer

The same test method was used per Example 1; however, instead of pre-cleaning a lap shear, it was dipped into an isopropanol contaminant solution. A lap was allowed to dry for 1 hour and the excess material “dabbed” off with a dry paper towel. The activator-impregnated inventive wipe was then used as the “cleaning towel”, which also left a primer film on the surface of Primer A where Adhesive A was used in all cases. Laps were assembled and tested as above.

TABLE 3
Tensile Strengths for Inventive Applicator
Applied Primers on Contaminated Lap Shears

| Contaminant | Tensile Strength (psi) |
|---|---|
| 5% 1000 centistoke silicone oil | 2,401 +/− 126 |
| 5% motor oil | 1,718 +/− 287 |
| 5% dioctyl phthalate | 2,817 +/− 152 |
| No contaminant | 3,230 +/− 115 |

The foregoing description is illustrative of particular embodiments of the invention, but is not meant to be a limitation upon the practice thereof. The following claims, including all equivalents thereof, are intended to define the scope of the invention.

1. An article for chemical reactant delivery comprising:
a chemical reactant that satisfies at least one condition of being solvated or liquid under delivery conditions;
an applicator pre-moistened with said chemical reactant; and
a chemical reactant impervious package having a pouch adapted to enclose said applicator.

2. The article of claim 1 wherein said package has a pouch defined in part by a temporary seal.

3. The article of claim 1 wherein said pre-moistened applicator is attached to said package.

4. The article of claim 1 wherein said applicator is selected from a group consisting of a wipe, a prep pad, a swab stick, and a sponge.

5. The article of claim 1 wherein said chemical reactant is selected from a group consisting of: main group and lanthanide series organometallics, coordination complexes of main group and lanthanide series metal salts and more specifically organo-tin compounds and organo-copper compounds, and copper acetyl acetonate or aldehyde amine condensates.

6. The article of claim 2 wherein said package has a peelable flap proximal to the said temporary seal.

7. A process for applying an adhesive comprising the steps of:
exposing a capillary action fed applicator pre-moistened with a solvated or liquid chemical reactant;
contacting said applicator with a first substrate independent of a user contact of said applicator;
applying a film of said chemical reactant to said first substrate; and
bringing a second substrate into contact with the first substrate with a curable material and said chemical reactant therebetween.

8. The process of claim 7 wherein said applicator is oriented below the first substrate while applying said film of said chemical reactant.

9. A commercial package comprising an article according to claim 1 together with instructions for the use thereof as a pre-moistened applicator for an chemical reactant.

10. The use of a selectively peelable or tearable package for applying a chemical reactant pre-moistened in an applicator.

11. The use of claim 10 where said chemical reactant is delivered independent of user contact therewith.
